(19) United States
(12) Patent Application Publication
(10) Pub. No.: US 2019/0212582 A1
(43) Pub. Date: Jul. 11, 2019

(54) DAMAGE TO REPAIR LIGHT FILTRATION RATIO

(71) Applicant: Photoprotective Technologies Incorporated, San Antonio, TX (US)

(72) Inventor: James Martin Gallas, San Antonio, TX (US)

(73) Assignee: Photoprotective Technologies incorporated, San Antonio, TX (US)

(21) Appl. No.: 16/245,252

(22) Filed: Jan. 10, 2019

Related U.S. Application Data
(60) Provisional application No. 62/615,930, filed on Jan. 10, 2018.

(51) Int. Cl. G02C 7/10; G02B 5/22; G02C 7/02

(52) U.S. Cl. CPC G02C 7/104; G02C 7/027; G02C 7/108; G02B 5/223

(57) ABSTRACT

A method that uses the transmission spectrum of an opthalmic lens to generate, as output, the ratio of the average transmission of sunlight that repairs the retina to the average transmission of sunlight that causes damage to the retina. This ratio is compared with a similar ratio for the naked eye that correlates with macular degeneration and allows the user to select a ratio that extends the risk of acquiring macular degeneration by multiples of an average lifetime.

### RELATED PRIORITY DATE APPLICATION

This application claims the benefit under 35 U.S.C. 119(e) of the U.S. provisional application No. 62/615930 filed on Jan. 10, 2018.

### FIELD OF THE INVENTION

The field of the invention relates to the field of light filters and, more particularly, to a method for determining the performance of the a light filter. Still more particularly, the present invention relates to the use of an algorithm to determine the performance of a filter based on its transmission spectrum of electromagnetic radiation.

### BACKGROUND OF THE INVENTION

Currently, the risks for acquiring age-related macular degeneration (AMD) are significant at 80 years of age and above. Methods for determining the average transmission of the high energy visible part (HEV) of sunlight through opthalmic lenses that increase the risk of (AMD) have been previously described by Gallas and Eisner in Eye Protection Factor (EPI) published by Elsevier, Chapter 23—Eye protection from sunlight damage, Comprehensive Series in Photosciences (Elsevier), Volume 3, 2001, Pages 439-455). The EPF for a particular opthalmic sun lens can estimate how much longer a person can live before he or she acquire AMD with that ophthalmic sun lens than without using that lens.

Applicant notes however, that while damage to the retina is being done by HEV light, repair from this damage can occur with the red and near infrared light parts of the sunlight or light source (Gallas, U.S. Pat. No. 9,726,910,). Therefore, the significant risk of acquiring AMD at 80 years of age must be the result of exposure to both sunlight that damages the retina and sunlight that repairs the retina, and a method that incorporates both repair and damage is needed to correctly predict the efficacy of an opthalmic lens to extend the age at which AMD occurs.

### SUMMARY OF THE INVENTION

A method is described for calculating the number of years that can be extended by using a specific sun lens before the risks of acquiring AMD are significant. The method uses the average percent transmission of damaging HEV light through an opthalmic lens and the average transmission of red and near infrared light that is associated with repair—also called photobiomodulation, or PBM—through the same ophthalmic lens as input to the calculation. The ratio of the transmission of light that repairs to the transmission of light that causes damage, is compared with the same ratio of transmissions through the naked eye, without any ophthalmic lens to filter the sunlight. Applicant has found that the latter ratio has a value of about 6 and correlates this ratio with the acquisition of AMD by the age of 80 to 100 years. By selecting sunglass lenses with the appropriate transmission spectra, the ratio of 6 can be increased and therefore the age can be predicted at which AMD occurs can also be increased.

### BRIEF DESCRIPTION OF THE DRAWINGS

For a detailed description of the preferred embodiment of the invention, reference will now be made to the accompanying drawings wherein:

FIG. 1 shows the emission intensity, I(1) for two angles of the sun;

FIG. 2 shows the action spectrum, A(1), for damage to the retina (from Ham W T et. al. SENSITIVITY OF THE RETINA TO RADIATION DAMAGE AS A FUNCTION OF WAVELENGTH, Photochem. Photobiol, (29): 735;

FIG. 3 shows the transmission spectrum of the human lens with age;

FIG. 4 shows the absorption spectrum of cytothrome-C;

FIG. 5 shows the transmission of light causing damage to the retina through the ocular lens pigment weighted by the diffuse sunlight spectrum and the action spectrum for damage to the retina with age;

FIG. 6 shows the transmission of light causing PBM through the ocular lens pigment weighted by the diffuse sunlight spectrum and the action spectrum for cytochrome c with age; and

FIG. 7 shows the ratio of T_{D} to T_{PBM}—with age.

### DETAILED DESCRIPTION OF THE INVENTION

The objective of this invention is to provide a method for to determining the transmission spectra of sunglasses that will enable an individual to estimate when they will be at risk of acquiring macular degeneration due to sunlight exposure that affects both damage and repair of their retina. In this invention, Applicant calculates first the percent transmission of damaging light to the retina as published by Gallas, and Eisner mentioned previously. Next, a calculation of the percent transmission of the red and near infrared light associated with repair is carried out. Both calculations are weighted averages of the transmission of the human lens as described in detail further below. Calculation of damage, T_{D}.

Previously, Applicant developed a way to simulate the transmission of photochemical damage to the retina by determining the average transmission of the ocular lens pigment—and weighting the transmission t(1) by the sunlight spectrum and the spectrum for damage, T_{D}=percent transmission of damaging HEV light

T_{D}=∫I(1)A(1)t(1)d1/∫I(1)A(1)d1˜S I(1)A(1)t(1)D1/S I(1)A(1)D1 1)
(380 nm to 500 nm)

The average transmission of damaging light over the wavelengths involved is found by weighting the transmission of the lens pigment by the distribution of sunlight and the action spectrum for damage as in eq 1):

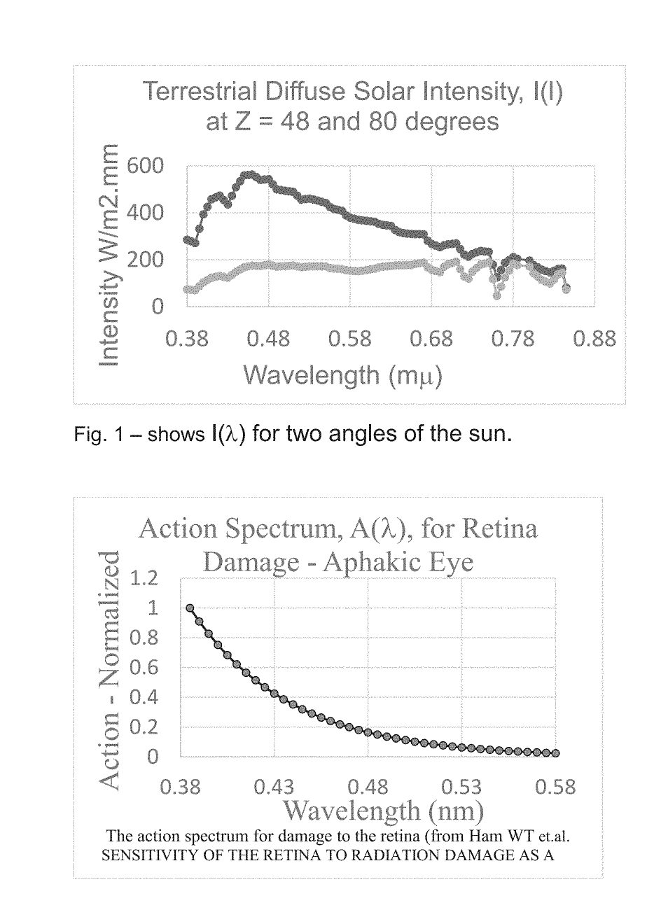

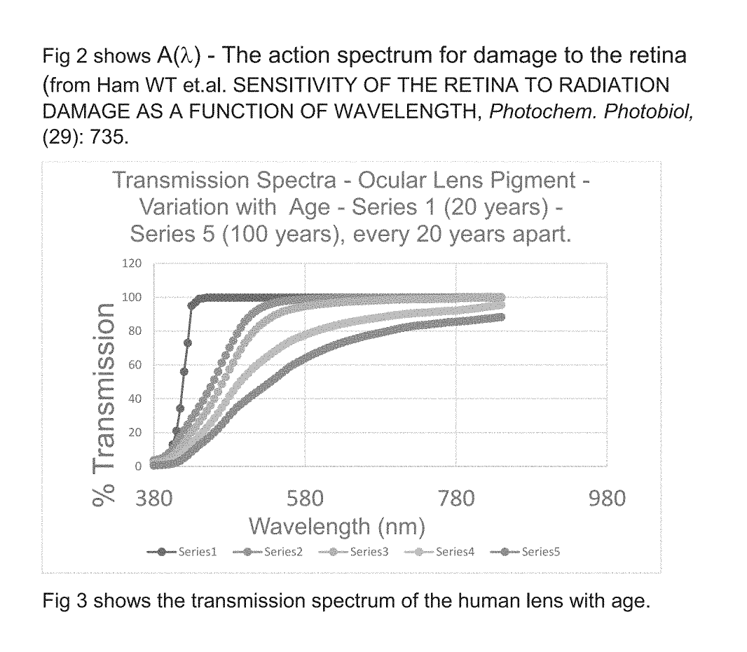

The wavelength region in the sum is limited to 380 nm to 500 nm because damage is relatively low for 1 greater than 500 nm; and the transmission of the lens for 1 less than 380 nm is relatively low. Here, I(1) represents the sunlight emission spectrum, for example shown in FIG. 1; A(1) represents the action spectra for damage to the retina, as shown in FIGS. 2; and t(1) represents the transmission spectrum of the human lens, as shown in FIG. 3 which can change with age.

### Calculation of Repair, T_{PBM}

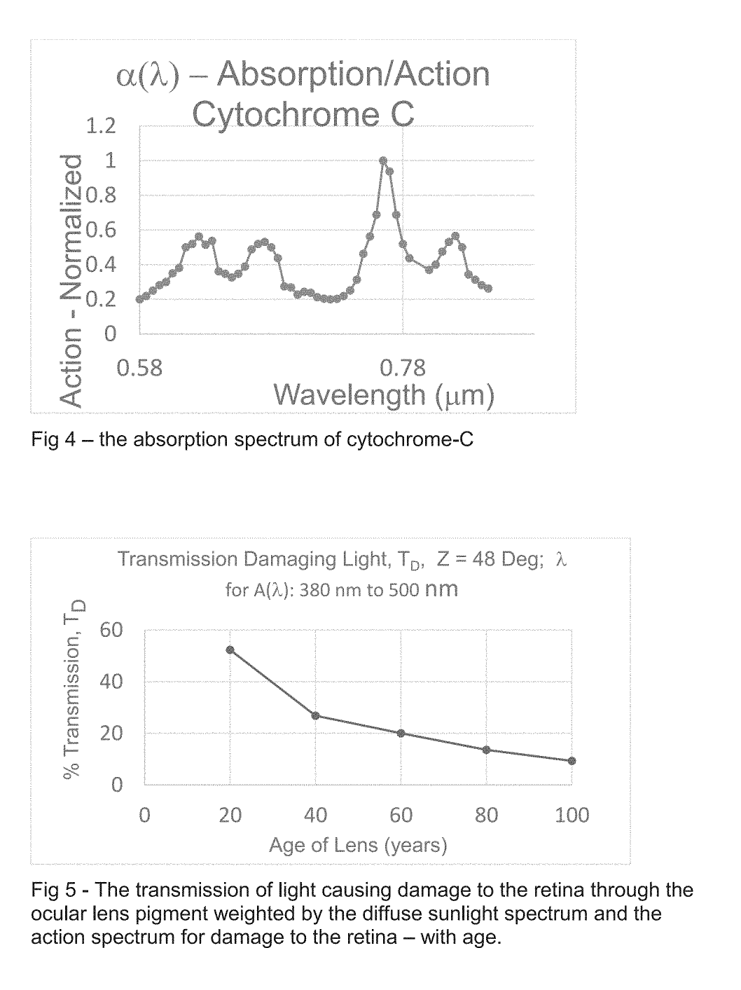

In presenting the action spectrum for PBM by way of absorption by cytochrome-C, Applicant has guessed that the absorption spectrum and the action spectrum can be used interchangeably. The same simulation of the transmission for the case of PBM is applied—except now the action spectrum for PBM is used, which is essentially the absorption spectrum of cytochrome c as shown in FIG. 4.

### Then,

T_{PBM}=percent transmission PBM light

=∫I(1)a(1)t(1)d1/∫I(1)a(1)d1 ˜S I(1)a(1)t(1)D1/S I(1)a(1)D1 2)
(600 nm to 700 nm) or (600 nm to 1000 nm)
   In this equation a(1) represents the absorption spectrum or the action spectrum of cytochrome-C.

In this way, it is possible to calculate these two fundamental entities with age−T_{D}=percent transmission of damaging HEV light; and

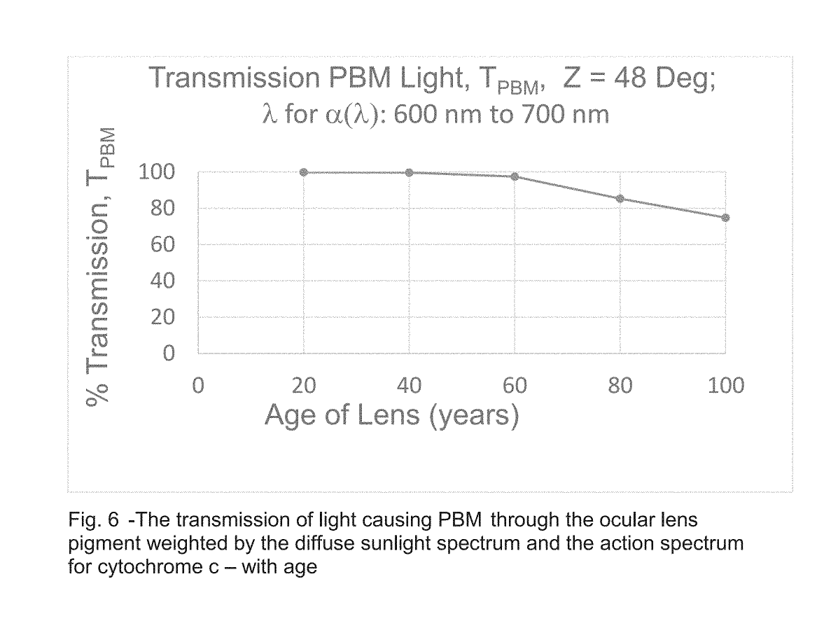

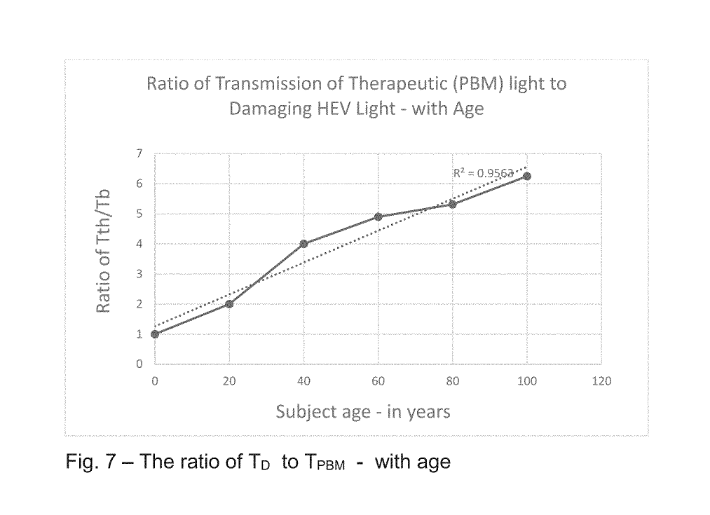

T_{PBM}=percent transmission PBM light—by using literature values of the lens transmission at different age groups—or better—at
different pigment concentrations (making sure that the optical density spectra are all exponential functions of the wavelength)
And we do this for different age groups 0 to 100 years. We wanted to do this analysis as a function of age because we wanted to see the progression of damage and repair as the age approached a point where we know problems occur. The results are shown in FIG. 5 and in FIG. 6
Ratio T_{PBM}/T_{D}
From the analysis of FIGS. 5 and 6—and directly from these figures, it is possible to calculate the ratio of the transmission of the therapeutic light to the damaging light—as an individual ages. The results are shown in FIG. 7. The data of FIG. 7 were obtained by taking the ratios of the values of Tₜₕ and T_{PBM} at each age (0, 20, 40, 60, 80, and 100), For age 0, these values were extrapolated backwards to age 0 to obtain 100%.
The results show that the rate of repair grows with age. Then, just based upon the transmission data for the ocular media, there is a
linear growth in the ratio of T_{PBM}/T_{D}. This means that the repair rate outpaces the damage rate—and yet significant retina damage
occurs with age: Many people acquire age-related macular degeneration (AMD) after the age of 55; and a significant percentage
acquire AMD by the age of 80.
Applicant discloses the application of the foregoing as software that can be used to gauge the incremental intensity of PBM light provided by a sunglass lens or a computer lens that could delay the onset of macular degeneration by any desired amount. For example, the delay could be set at 100 years of age by a 70 percent increase in the transmission of PBM light by modifying a sunglass lens appropriately. In the case of U.S. Pat. No. 9,726,910, for example, the concentration of fluorescent molecules incorporated into the lens to enhance the intensity of PBM light emitted by the sunglass lens can be increased so as to increment the PBM light transmitted by 70 percent.
Example 1. From FIG. 7, the ratio of repair to damage—based upon the transmission of the corresponding types of light (light that causes damage and light that causes repair) through to the ocular media and to the retina—is approximately 6 over a period of 100 years and for the average person. If a person wishes to reduce this ratio by using protective eyewear that has a specific transmission spectrum, it is a simple matter of using the equation 1) of this application for T_{D} multiplied by the transmission of a specific sunglass lens according to the methods of described in the Elsevier 2001 publication by Gallas and Eisner. As an example, if a sunglass lens has an average transmission of high energy visible light, weighted by the action spectrum for damage and the sunlight spectrum—equal to 50%, then the total transmission of damaging light is found by calculating Tₜₒₜₐₗ×T_{D} at each age (20, 40, 60, 80, 100) and then taking the ratio of Tₜₕ/T_{D} (or equivalently T_{PBM}/T_{D}). Then one finds a ratio of about 7.9. This value is not so different from the unprotected value of 6. However, if the calculation is repeated for an average transmission of HEV light of 10%, the new ratio is about 40, which is many multiples of 100 years.
Example 2. Likewise, it is possible to increase the transmission of PBM light (the red and near IR light associated with repair) in order to increase the ratio of T_{PBM}/T_{D}—rather than reducing the denominator. However, according to FIG. 6, there is not as much latitude for improvement by increasing T_{PBM}. It is still at almost 80% at 100 years and slowly decreasing. One does have the option to use an interference (anti-reflecting) coating for wavelengths between 600 nm and 1000 nm as described in U.S. application Ser. No. 12/807,656. Still more useful is the ability to increase the amount (transmission) of PBM light by using a fluorescent coating on a sun lens as described in U.S. Pat. No. 9,726,910.
This invention underscores the fact that if a lifetime exposure of a person's eyes to sunlight results in macular degeneration, then the net effect is a combination of damage and repair, that some of the sunlight leads to damage and some of the exposure leads to repair, that both are a rate process and both are dictated by the transmission spectrum of the sunglass lens. Although sunlight has been used primarily as the light source in this application, the invention is not limited to sunlight as a light source and the results can apply to other light sources such as indoor lighting and electronic displays.

The above description is illustrative of the preferred embodiment and many modifications may be made by those skilled in the art without departing from the invention whose scope is to be determined from the literal and equivalent scope of the claims below.

What is claimed is:

1. A method for determining the effect of utilizing an ophthalmic lens that filters light in delaying the potential onset of macular degeneration in an individual, comprising the steps of:
calculating the average transmission of high energy visible light by the ophthalmic lens that causes damage to the retina of the individual to determine an ophthalmic lens damaging transmission;
calculating the average transmission of light by the ophthalmic lens that repairs the retina of the individual to determine an ophthalmic lens repairing transmission;
determining the ratio of the ophthalmic lens repairing transmission to the ophthalmic lens damaging transmission to obtain a first ratio; and
comparing the first ratio with a ratio of a repairing transmission without the ophthalmic lens to a damaging transmission without the ophthalmic lens.

2. A method for estimating the time required for a person to experience a significant increase in the risk of acquiring macular degeneration wherein the following steps are taken:
(1). the ratio of two average transmission values of light by an ophthalmic lens are calculated;
(2). the first average transmission causes repair and is determined by calculating the transmission of the ophthalmic lens, and weighted by the transmission spectrum of the ocular lens, weighted by the absorption spectrum of cytochrome C, and weighted by the emission spectrum of sunlight over the wavelengths, from 600 nm to 1200 nm; and the second average transmission causes damage and is determined by calculating the transmission of the ophthalmic lens and weighted by the transmission spectrum of the ocular lens, weighted by an action spectrum for damage to the retina and by the emission spectrum of sunlight between the wavelengths of 380 nm and 500nm;
(3). the ratio of the first average transmission spectrum to the second average transmission spectrum is calculated;
(4). a ratio of (2). Is calculated without the ophthalmic lens—a value nominally of 6.
(5). The ratio of (3). Is compared with the value of (4) wherein the transmission spectrum of the ophthalmic lens is selected so as to be larger than the ratio of (4).
